(19) United States
(12) Patent Application Publication
(10) Pub. No.: US 2018/0176645 A1
(43) Pub. Date: Jun. 21, 2018

(54) METHOD FOR PROVIDING FEEDBACK FOR TELEVISION ADVERTISEMENTS

(71) Applicant: ARRIS Enterprises LLC, Suwanee, GA (US)

(72) Inventors: Javier Reyes Sanchez, General Escobedo (MX); Luis Alberto Valencia Medina, Monterrey (MX); Aldo David Sanchez Rodriguez, Monterrey (MX); Gregorio Martinez Aguilar, Monterrey (MX)

(21) Appl. No.: 15/380,631

(22) Filed: Dec. 15, 2016

(51) Int. Cl. H04N 21/466; H04N 21/81; H04N 21/84; H04N 21/4363; H04N 21/61; H04N 21/434; H04N 21/658; H04N 21/231

(52) U.S. Cl. CPC H04N 21/4667; H04N 21/812; H04N 21/84; H04N 21/43637; H04N 21/231; H04N 21/6193; H04N 21/4343; H04N 21/6582; H04N 21/6168

(57) ABSTRACT

A set-top box receives a program transport stream from a headend via a cable or satellite network. The program transport stream includes an advertisement identified by a data packet identifier (PID). The advertisement has at least one advertisement packet with the data PID and advertisement metadata. Upon determining that the data PID identifies the advertisement, set-top box extracts advertisement metadata from the at least one advertisement packet in the program transport stream. Set-top box sends the extracted advertisement metadata to a mobile device over a wireless communication network. In response to sending the extracted advertisement metadata to the mobile device, set-top box receives an analytics report of user interaction with the extracted advertisement metadata from the mobile device over the wireless communication network. Set-top box sends the analytics report of user interaction with the extracted advertisement metadata to the headend via the cable or satellite network.

### TECHNICAL FIELD

The examples described herein, in general, relate to techniques and equipment to analyze advertising campaigns, such as for a multiple-system operator (MSO).

### BACKGROUND

An MSO is an operator of a multiple cable or direct-broadcast satellite television system. The current method for obtaining advertisement penetration is through Nielsen ratings. Unfortunately, Nielsen ratings may not involve or benefit an MSO directly. Accordingly, there is an unexploited market for MSO companies to analyze feedback from advertising campaigns and sell this marketing data to advertisement sponsors.

### SUMMARY

In an example, a set-top box includes a network communication interface, a processor coupled to the network communication interface, a memory accessible to the processor, and programming in the memory. Execution of the programming by the processor configures the set-top box to perform functions, including functions to receive a program transport stream from a headend via a cable or satellite network. The program transport stream includes an advertisement identified by a data packet identifier (PID). The advertisement has at least one advertisement packet with the data PID and advertisement metadata. The programming in the memory further configures the processor to upon determining that the data PID identifies the advertisement, extract advertisement metadata from the at least one advertisement packet in the program transport stream. The programming in the memory further configures the processor to send the extracted advertisement metadata to a mobile device over a wireless communication network and in response to sending the extracted advertisement metadata to the mobile device, receive an analytics report of user interaction with the extracted advertisement metadata from the mobile device over the wireless communication network. The programming in the memory further configures the processor to send the analytics report of user interaction with the extracted advertisement metadata to the headend via the cable or satellite network.

In an example, a method includes sending from a headend to a set-top box via a cable or satellite communication network, a program transport stream including metadata of an advertisement identified by a data packet identifier (PID). The advertisement has at least one advertisement packet with the PID and the advertisement metadata. The method further includes in response to sending the advertisement metadata, receiving at the headend from the set-top box an analytics report of user interaction with the advertisement metadata at a mobile device. The method further includes storing at the headend the analytics report of user interaction in a database and compiling at the headend and at a predetermined time the analytics report of user interaction with other analytics reports of user interaction to generate a compiled analytics report of user interaction. The method also includes transmitting the compiled analytics report of user interaction to a vendor server.

In an example, a non-transitory machine-readable medium contains machine-readable programming instructions to cause a mobile device to receive at a mobile device a program transport stream and a plurality of advertisements associated with the program transport stream from a set-top box via a wireless communication network. Each advertisement includes respective advertisement metadata. The instructions further cause the mobile device to store the plurality of advertisements including respective advertisement metadata in a memory. The instructions further cause the mobile device to launch an application by a processor of the mobile device and present a user interface display of the launched application on a touchscreen display device of the mobile device. The user interface display includes a list of the plurality of advertisements. The instructions further cause the mobile device to in response to an input on the touchscreen display selecting an advertisement from the plurality of advertisements by a user of the mobile device, monitor user interaction with the selected advertisement. The instructions further cause the mobile device to generate an analytics report of user interaction with the selected advertisement. The analytics report of user interaction includes: (i) an indication of selection of the selected advertisement, and (ii) an event specifying an action taken with the respective advertisement metadata. The instructions further cause the mobile device to store the generated analytics report in the memory of the mobile device and send the analytics report of user interaction with the selected advertisement to the set-top box via the wireless communication network.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The figures depict one or more implementations in accordance with the present teachings by way of example only, not by way of limitation. In the figures, like reference numbers refer to the same or similar elements.

FIG. 1 is a block diagram of a system for providing feedback for television advertisements.

FIG. 2 is a flowchart of the operation of the headend, set-top box, and mobile device in FIG. 1, during transport of a program transport stream with an advertisement and collection of feedback.

FIG. 3 is a flowchart of the operation of the set-top box in FIG. 1, when receiving a program transport stream with an advertisement from a headend and processing feedback.

FIG. 4 is a flowchart of the operation of the headend in FIG. 1, when transmitting a program transport stream with an advertisement to a set-top box and processing feedback.

FIG. 5 is a flowchart of the operation of the mobile device in FIG. 1, when receiving a program transport stream with an advertisement from a set-top box and generating feedback.

FIG. 6 shows an example of a hardware configuration for the set-top box in FIG. 1, in simplified block diagram form.

FIG. 7 shows an example of a hardware configuration for the headend in FIG. 1, in simplified block diagram form.

FIG. 8 shows a hardware configuration of a mobile device in FIG. 1, in simplified block diagram form.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detailed comment in order to avoid unnecessarily obscuring aspects of the present teachings.

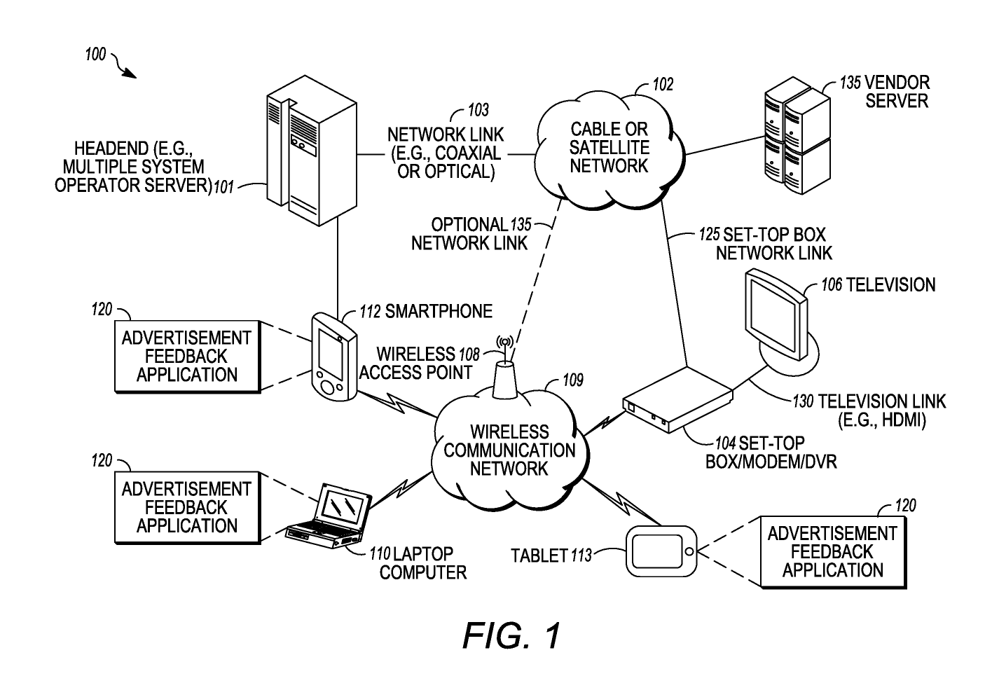

Shown in the block diagram of FIG. 1 is an example system 100 for providing feedback for television advertisements. The system 100 includes at least one mobile device and a set-top box 104 that receives advertisements from a headend 101. The headend 101 receives communication signals (e.g., cable television signals), processes the television signals, and distributes the television signals for broadcast to a local region. As shown, headend 101 is connected to a television system network, such as cable or satellite network 102, via a network link 103. The cable or satellite network 102 includes Internet capabilities. The network link 103 can be a coaxial or optical connection.

In the example, the headend 101 pushes out advertisements by inserting the advertisements into an MPEG transport stream, and in response receives analytics for the advertisements upon completion of the advertising campaign, such as feedback on a specific advertisement's impact (e.g., viewing by the user). Subsequently, headend 101 stores and compiles the analytics among various or all users of the cable or satellite network platform 102 and may transmit the analytics to a vendor server 135 utilized by the advertiser or advertisement sponsor. The vendor server 135 is in communication with the headend 101 via the cable or satellite network 102. The compiled advertisement analytics information can be used by the cable providers and vendors to understand the effectiveness of distributed commercial advertisements.

System 100 includes an example optical or cable network compatible video receiver and decoder (colloquially referred to as a “set-top box”), a modem and/or a digital video recorder (DVR) as shown generally at 104. For convenience, the device 104 is referred to as a set-top box (STB). Although the example STB 104 is shown as including these specific elements, it is contemplated that another STB may have more or fewer elements. STB 104 is in communication with headend 101 via the cable or satellite network 102 through a set-top box network link 125 (e.g., coaxial or optical cable) and is also connected to a television 106 via television link 130, such as an HDMI connector. If the television 106 is equipped with a wireless network communication interface (e.g., a Smart TV), then television 106 can also be in communication with the wireless access point 108, in which case television 106 may operate in a manner similar to mobile devices 110, 112, and 113 and may include advertisement feedback application 120. Although FIG. 1 shows wireless connections between the access point 108 and the STB 104 and/or television 106, it is contemplated that these connections may be wired connections. For example, the access point 108 may be a wireless router that may be used to implement both wired and wireless connections.

The example system 100 also includes a local area network, shown as wireless communication network 109, which includes a wireless access point 108 (e.g. WiFi access point/router and/or network gateway); although other in-home networking technologies may be used. Wireless communication network 109 can include a Bluetooth®, ZigBee®, or WiFi network. Alternatively, the wireless communication network can include a telecommunications network. System 100 also includes end user devices, including mobile devices such as a laptop/personal computer 110, smartphone 112, and a tablet computer 113. Wireless access point 108 enables the laptop computer 110, smartphone 112, and tablet computer 113 to utilize services offered through the STB 104 and the connection of the STB 104 to the cable or satellite network 102, such as for Internet access and media content distribution.

The wireless access point 108 can be a WiFi access point/router that indirectly connects to the cable or satellite network 102 through a separate network gateway. However, the wireless access point 108 may optionally connect to the cable or satellite network 102 via a network link 103. In this example, wireless access point 108 may be both a WiFi access point/router and a network gateway that directly connects to the cable or satellite network 102. Accordingly, the wireless access point 108 behaves as a transport box by pushing advertisement feedback data, such as an analytics report of user interaction, back to the headend 101. Such a network gateway is a data device that provides access between a wide area network such as 102 and the local wireless telecommunication network 109 at the premises (for use by devices communicating through the local on-premises network). The physical network link 135 to the cable or satellite network 102 may be similar to set-top box 104, such as an optical fiber or cable link to a cable TV network. The wireless access point 108 provides routing, access, and other services for the end user equipment operating at the premises. The wireless access point 108 may also include sufficient storage to support media content, such as moving picture experts group (MPEG) transport streams, downloading operations, e.g. to obtain from servers, such as headend 101, or the like on the cable or satellite network 102, store the content, and forward the content to end user devices on wireless communication network 109.

A transport stream is a standard digital container format for transmission and storage of audio, video, and program and system information protocol (PSIP) data used in broadcast systems such as digital video broadcasting (DVB), advanced television systems committee (ATSC), and internet protocol television (IPTV). A single program transport stream is referred to as a Single Program Transport Stream (SPTS). A transport stream with more than one program is referred to as a Multi Program Transport Stream (MPTS). It should be understood that a program transport stream covers both SPTS and MPTS.

Transport streams can include segment(s) to signal splicing and insertion of advertisements. Such transport streams can use digital program insertion (DPI) capabilities to allow advertisement insertion and insertion of other content types. A splice information table, which pertains to a given program, is carried in one or more packet identifiers (PIDs) referred to by the program's program map table (PMT). A PID is a unique 13-bit value used to identify the type of data stored in a packet payload.

The segment is either a program, a chapter, a provider advertisement, a distributor advertisement, or an unscheduled event. A program is a collection of video, audio, and data packet identifier (PID) streams that share a common program number within the MPTS. The program is typically a performance or informative presentation broadcast on television, typically with a duration over 5 minutes (long-form content). An advertisement (ad) is an inducement to buy or patronize and typically has a duration under 2 minutes (short-form content).

In this example, each program can be described by a program map table (PMT) which has a unique PID, and the elementary streams associated with that program have PIDs listed in the PMT. A PID stream encompasses all the packets with the same PID within a transport stream. For example, the transport stream used might contain three programs and each program might contain fifteen advertisements, to represent three television channels and 15 advertisements per channel. Hence, in the example, each channel includes one video stream, one audio stream, 15 advertisement segments, and any corresponding metadata. A receiver, such as set-top box 104, wishing to decode a particular channel or advertisement decodes the payloads of PIDs associated with the respective program, including the video stream, the audio stream, and the 15 advertisement segments associated with the program. The set-top box 104 can discard the contents of all other PIDs that are not listed in the PMT.

FIG. 1 describes examples where the program transport streams may be delivered to the set-top box 104 via headend 101. The set-top box 104 listens for an MPEG program transport stream, identifies a data PID that signifies an advertisement, and, upon identifying the data PID signifying the advertisement, stores the advertisement in memory to be ultimately transmitted to mobile devices 110, 112, 113 or a Smart TV type television 106. This enables the user to interact with the advertisement by way of the respective advertisement metadata during or after viewing the advertisement at mobile devices 110, 112, 113. For example, the user may contact the advertiser/vendor by calling a phone number embedded in the advertisement metadata.

Headend 101 may be a MSO that transmits stored media content (e.g., program transport streams) to set-top box 104. A Digital Program Insertion (DPI) splicing method can be used to insert advertisements into MPEG transport streams at headend 101, for example, using commercially available platforms from Arris Group, Inc., known as CAP-1000, CAP-1010 and DM64000. The program transport stream includes a special data packet identifier (PID) which contains additional information fields/parameters (e.g., advertisement metadata) from a vendor, such as a company name, a product name, a web site address, a phone number, a physical or mailing address, and an advertising campaign identifier. The advertising campaign identifier may uniquely identify a particular advertisement for feedback tracking purposes.

Set-top box 104 parses the program transport stream for relevant advertisement metadata. Once the advertisement metadata is obtained and formatted, the set-top box 104 pushes the advertisement metadata to an advertisement feedback application 120 on mobile devices 110, 112, 113, 116 over the wireless communication network 109 via the wireless access point 108.

The example advertisement feedback application 120 provides the end users with the ability to capture information concerning the advertisements that the end users watch for later referral. This can be particularly useful if the advertisements are coupled with incentives, such as discount promotions or coupons. The advertisement feedback application 120 is linked to the end user's set-top box 104, which gives the system the capacity to associate the end user with the output video stream and, therefore, with the displayed advertisements. The advertisement feedback application 120 lists the advertisements and the end user may select the ads he/she is interested in and act on the advertisements, notifying the headend 101 of each event. Actions may include user interactions with the advertisement metadata, such as visiting the vendor's web site, making a phone call to the phone number, sharing the advertisement information, and/or purchasing an advertised product. An action may also include an indication that the user did not interact with the advertisement. The headend 101 at the MSO company receives the user's notifications and events (advertisement feedback) via set-top box 104, processes and analyzes the notifications and events, and licenses or sells the feedback data to MSO's sponsors/vendors in order to increase sponsors' business.

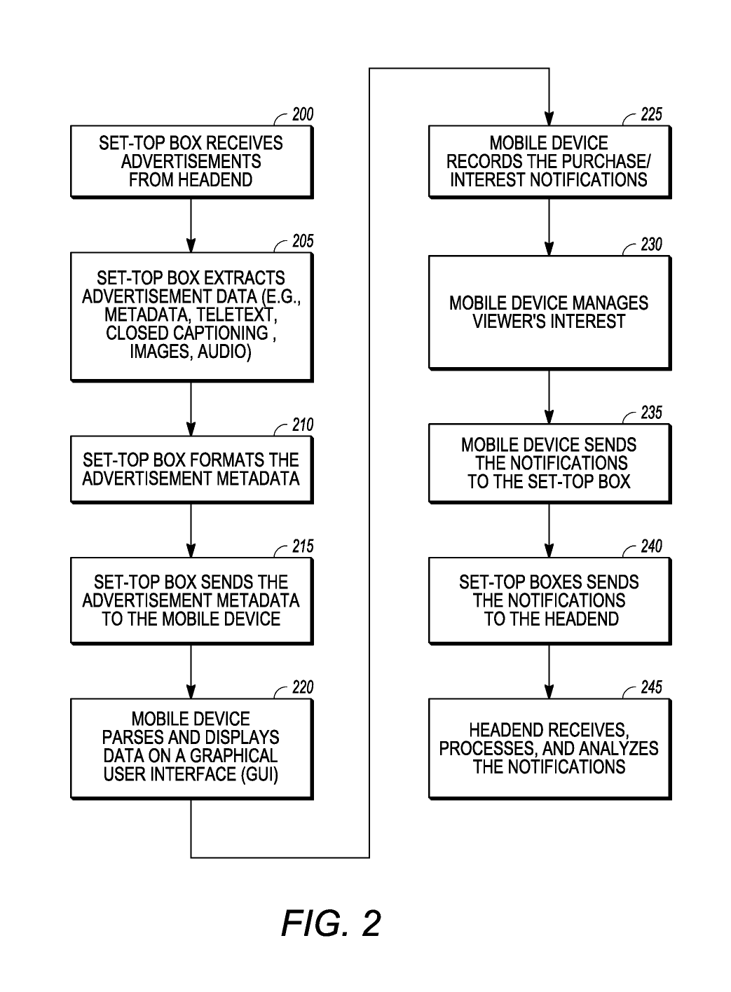

FIG. 2 illustrates a procedural flow executed on the headend, set-top box, and mobile device of FIG. 1 during transport of a program transport stream with an advertisement and collection of feedback. Although shown as occurring serially, the blocks of FIG. 2 may be reordered or parallelized depending on the implementation, as discussed below.

Beginning in step 200, set-top box 104 receives advertisements from headend 101. Set-top box 104 searches for a data PID indicating an advertisement carried in the program transport stream and collects all packets sharing that data PID. In response to receiving advertisements from headend 101, in step 205, set-top box 104 extracts advertisement metadata e.g., such as company name, product name, web site address, phone number, mailing address, advertising campaign identifier) as well as teletext, closed captioning, images, and audio data from the advertisement. For example, set-top box 104 parses the advertisement metadata from all of the collected packets sharing the data PID from the program transport stream, in other words, the collected advertisement packets carried along with the MPEG video stream. In other embodiments, it is contemplated that the advertising packets having a particular PID may not be collected but may be processed as they are received to extract the advertising metadata.

Continuing now to step 210, set-top box 104 formats the extracted advertisement metadata into a usable data structure, such as a database table stored in memory. Next, in step 215, the set-top box 104 sends the extracted advertisement metadata to a mobile device, such as by pushing the metadata to mobile devices 110, 112, 113 via wireless communication network 109.

In step 220, the mobile device parses and displays the metadata on a graphical user interface (GUI) of the mobile device. Advertisement feedback application 120 pulls the advertisement metadata from set-top box 104, processes the advertisement metadata by storing the data that can be displayed, and displays advertisement metadata using the GUI.

Continuing to step 225, the advertisement feedback application 120 records purchase or other user interest notifications, such as user interactions with the advertisement metadata. Recorded user interest notifications include, for example, a phone call to a vendor, clicking on the vendor's web site, visiting the vendor's physical location (e.g., viewing of the physical location address or displaying the vendor's physical location address on a map), sharing the advertisement metadata information, purchasing the advertised product online, or purchasing the product at the vendor's physical address). If none of these actions is detected, the recorded user interest notification may include an indication of no interaction. When the user interacts with any of the fields of the extracted advertisement metadata, such as a company name, a product name, a web site address, a phone number, a physical/mailing address, and an advertising campaign identifier, the advertisement feedback application 120 monitors the interactions and then records the interactions in memory. When the advertisement feedback application 120 detects the user is interested in the vendor phone number or visits the web site address, and such detected interactions are ultimately propagated back to the vendor server 135 by headend 101.

Subsequently, in step 230, the mobile device manages the interest of the user that viewed the advertisement (viewer) by generating an analytics report for the user interactions. For example, the analytics report includes the interaction of the user with the fields of the extracted advertisement metadata. The analytics report can include data indicating whether a single or multiple product purchases were made by the user, whether a delayed purchase of the product was made by the user, whether the product was immediately purchased, whether a referenced purchase was made (e.g., by the user's sharing of the advertisement data with another user/party, also known as an assist). The analytics report of user interaction can also indicate advertisements seen/viewed by a user and products selected and purchased. The data in the analytics report tracks, among various users, what the actual impact is on the community, for example, whether the user is sharing the web site address with other users of the platform.

Generating the analytics report of user interaction on the mobile device can advantageously avoid having the headend 101 expend valuable computing resources, such as memory space, CPU processing, and network bandwidth, to generate the analytics report. This use of resources can lead to service slowdowns or disruptions. To avoid such potential television service slowdowns or disruptions at the headend 101, the mobile device generates the analytics report based on user interaction and then propagates the report to the set-top box 104 and the headend 101 where the report is ultimately stored to provide feedback on whether the advertisement is having an effect on customers.

In step 235, the mobile device sends the notifications of user interaction with the advertisement metadata to the set-top box 104. The generated analytics report of user interaction is transmitted via the wireless communication network 109 to the set-top box 104. In other embodiments, the generated analytics report of user interaction or notifications are sent from the mobile device to set-top box 104 or headend 101 via other available networks, such as a cellphone network or the Internet.

Proceeding now to step 240, the set-top box 104 sends the notifications to the headend 101. For example, the generated analytics report of user interaction is transmitted via the cable or satellite network 102 to the headend 101.

Finishing in step 245, the headend 101 receives, processes, and analyzes the notifications of user interaction from various set top box(es) 104 on the cable or satellite network 102. Results, such as the generated analytics report of user interaction, are then compiled and stored in a storage device of the headend 101.

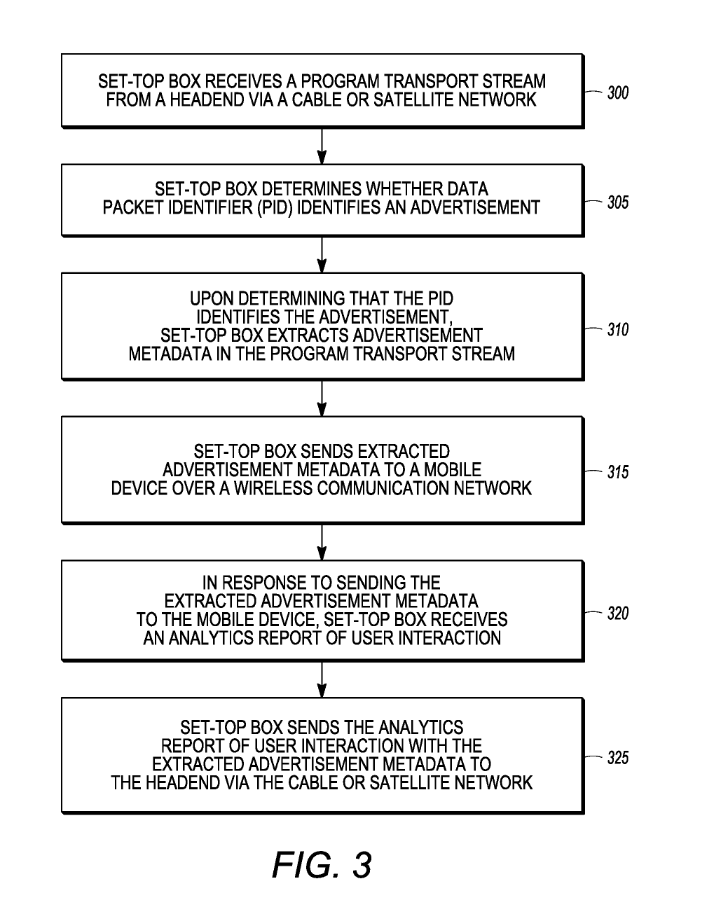

FIG. 3 is a procedural flow of the operation of the set-top box 104 in FIG. 1, when receiving a program transport stream with an advertisement from a headend and when processing feedback. Beginning in step 300, set-top box 104 receives a program transport stream from a headend 101 via a cable or satellite network 102. The program transport stream includes an advertisement identified by a data packet identifier (PID). The advertisement has at least one advertisement packet with the PID and advertisement metadata. For example, the program transport stream is a moving picture experts group (MPEG) transport stream.

In step 305, the set-top box determines whether the PID identifies the advertisement, for example, by searching the program map table (PMT). Continuing to step 310, upon determining that the PID identifies the advertisement, set-top box 104 extracts the advertisement metadata from the at least one advertisement packet in the program transport stream. Extracting the advertisement metadata may include parsing at least one of a company name, a product name, a web site address, a phone number, a mailing or physical address, and an advertising campaign identifier that corresponds to the advertisement from the advertisement metadata of the at least one advertisement packet. The parsed advertisement metadata is then stored in an advertisement table in the memory of the set-top box 104.

In step 315, the set-top box 104 sends the extracted advertisement metadata to one or more of the mobile device(s) 110, 112, 113 over a wireless communication network 109. Sending the extracted advertisement metadata to the mobile device can include retrieving the parsed advertisement metadata from the advertisement table and generating at least one wireless communication network packet that includes the extracted advertisement metadata as one or more parameters. The generated wireless communication network packet(s) is then transmitted to the mobile device(s).

In one implementation, the wireless communication network is a local area network (LAN) and the extracted advertisement metadata can be sent to the mobile device via a network gateway over the LAN. The wireless communication network can operate, for example, according to Bluetooth, ZigBee, or WiFi protocols or according to a telecommunications protocol such as 3G or 4G LTE.

Continuing now to step 320, in response to sending the extracted advertisement metadata to the mobile device(s) 110, 112, 113, set-top box 104 receives an analytics report for the user interaction with the extracted advertisement metadata from the mobile device(s) 110, 112, 113 over the wireless communication network 109. An example analytics report includes at least one of: (i) an indication of selection of the advertisement by a user of the mobile device; and (ii) an event that specifies an action including at least one of visitation of the web site address by the user, calling of the phone number by the user, sharing the extracted advertisement metadata with another user, and purchase of the advertised product by the user or no interaction by the user. In one implementation, the analytics report may also include demographic information about the user, such as age, gender and zip code. The analytics report is sent to the headend 101, at step 325, via the cable or satellite network 102, for example, as packetized data in accordance with the data over cable service interface specification (DOCSIS).

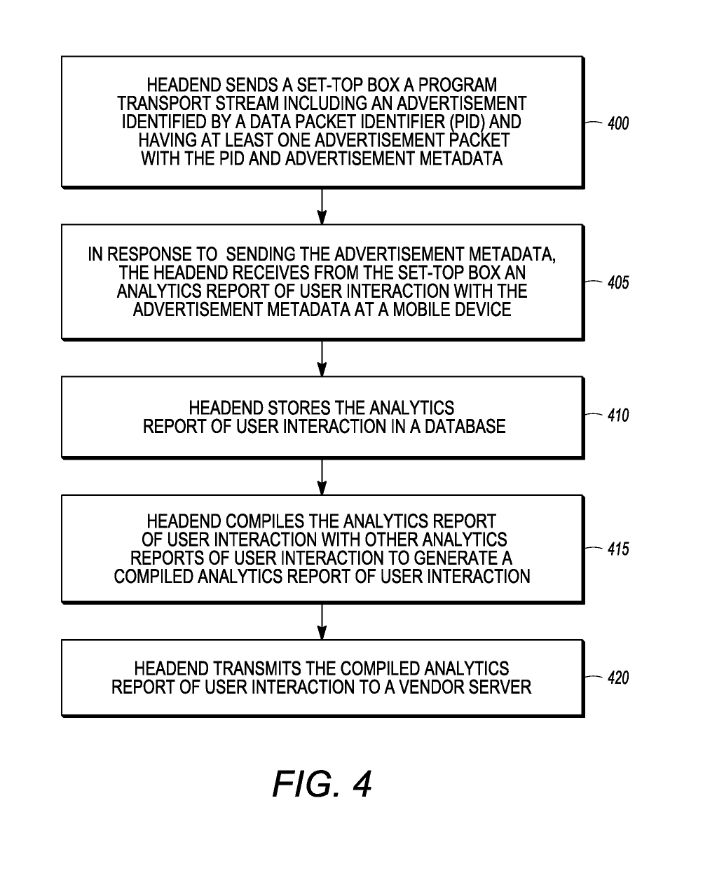

FIG. 4 is a procedural flow of the operation of the headend 101 in FIG. 1, when transmitting a program transport stream with an advertisement to a set-top box 104 and when processing feedback. In step 400, headend 101 sends a program transport stream including an advertisement identified by a data packet identifier (PID) to the set-top-box 104 via a cable or satellite communication network 102. The advertisement has at least one advertisement packet with the data PID and advertisement metadata. Advertisement metadata includes at least one of a company name, a product name, a web site address, a phone number, a mailing address, and an advertising campaign identifier that corresponds to the advertisement.

Moving to step 405, in response to sending the advertisement metadata, headend 101 receives, from the set-top box 104, an analytics report of user interaction with the advertisement metadata at mobile device(s) 110, 112, 113. As described above, the example analytics report includes one or more of: (i) an indication of display of the advertisement to a user of the mobile device; and (ii) an event that specifies an action including at least one of visitation of the web site address by the user, calling of the phone number by the user, sharing the extracted advertisement metadata with another user, purchase of the advertised product by the user or no interaction with the advertisement.

Continuing to step 410, the headend 101 stores the received analytics report of user interaction in a database. Storing the analytics report may include extracting the advertising campaign identifier and then storing the analytics report in the database indexed by the advertising campaign identifier. The stored report also includes an identity of the user, a date of user interaction, and a time of user interaction as one or more fields in a database record.

Proceeding to step 415, headend 101 compiles, at a predetermined time period (e.g., hourly or every 15 minutes), the stored analytics report with other, previously stored analytics reports which may have been received from different set-top boxes on the cable or satellite network 102 to generate a compiled analytics report of user interaction. Compiling the analytics report includes retrieving, from the database, analytics reports having a shared advertising campaign identifier. The retrieved analytics reports are combined to generate the compiled analytics report of user interaction. The compiling may include, for example, tallying the different types of interactions. It may also include breaking down the interactions based on any demographic information that may have been included in the analytics reports. Finishing in step 420, the headend 101 transmits the compiled analytics report of user interaction to a vendor server 135.

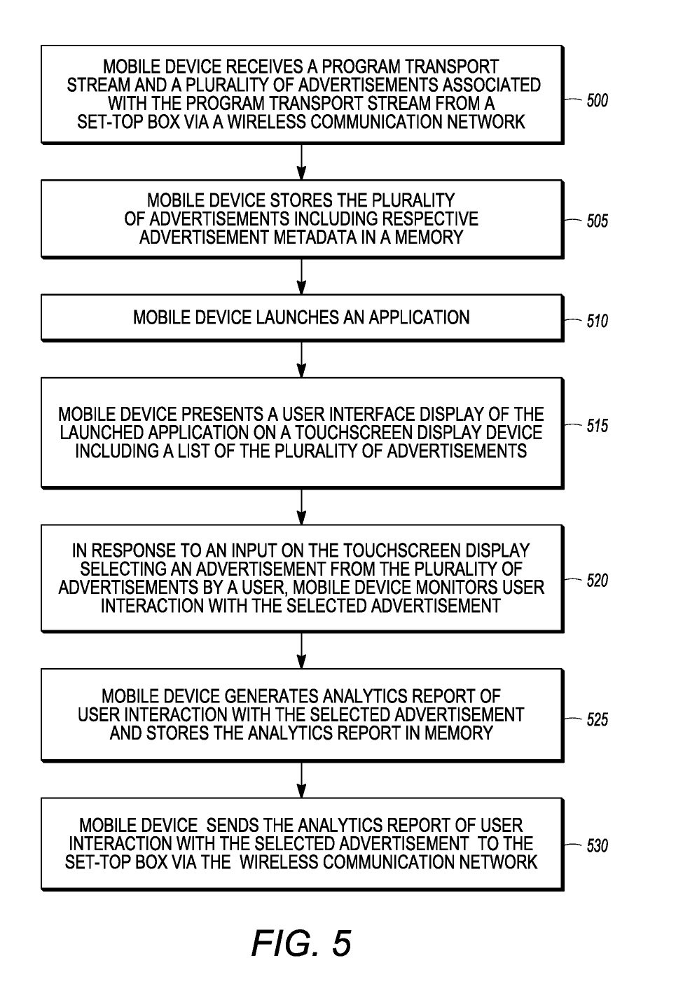

FIG. 5 is an example procedural flow of the operation of the mobile device(s) 110, 112, 113 in FIG. 1, when receiving a program transport stream with an advertisement from a set-top box 104 and generating feedback. Beginning in step 500, mobile device(s) 110, 112, 113 receives metadata associated with one or more advertisements in the program transport stream being processed by the set-top box 104 via a wireless communication network 109. The advertisement metadata for each advertisement includes least one of a company name, a product name, a web site address, a phone number, a mailing address, and an advertising campaign identifier. The wireless communication network may be a local area network, a mesh network or a personal area network (PAN), for example Alternatively, the mobile devices may receive the advertisement metadata as a data message (e.g. a short messaging service (SMS) message) from a telecommunications network.

Moving to step 505, mobile device(s) 110, 112, 113 stores received advertisement metadata in a memory. Storing the respective advertisement metadata in the memory may include parsing at least one of a company name, a product name, a web site address, a phone number, a mailing address, and an advertising campaign identifier that corresponds to the advertisement from at least one advertisement packet. The parsed advertisement metadata may be stored in an advertisement table in the memory of the mobile device. In addition to the metadata, the set-top-box 104 may transmit and the mobile device 110, 112, 113 may receive and store the video and audio data of the advertisement.

Proceeding to step 510, a processor of the example mobile device(s) 110, 112, 113 launches an application, such as advertisement feedback application 120. In step 515, mobile device(s) 110, 112, 113 presents a user interface display of the launched application on a touchscreen display device of the mobile device(s) 110, 112, 113. The user interface display includes a list of the advertisements for which metadata has been stored by the mobile device.

Continuing to step 520, in response to an input on the touchscreen display selecting a first advertisement from the plurality of advertisements by a user of the mobile device(s) 110, 112, 113, the mobile device may display questions based on the received metadata or, if the audio and video data for the selected advertisement is available, may display the selected advertisement to the user. The application then monitors user interaction with the selected advertisement. In step 525, based on the monitored interaction, the mobile device(s) 110, 112, 113, generates an analytics report of user interaction with the selected advertisement, as described above. The generated analytics report is stored in the memory of the mobile device(s) 110, 112, 113. The event specifying the action taken with the respective advertisement metadata includes at least one of, no interaction, visitation of the web site address by the user, calling of the phone number by the user, sharing of the respective advertisement metadata by the user, and purchase of the product by the user. The application may ask the user for demographic information (e.g. age, gender, zip code) and further ask the user if the demographic information may be shared with the advertiser. When the user grants permission, the analytics report may also include at least a portion of the demographic data.

Proceeding to step 530, mobile device(s) 110, 112, 113 sends the analytics report to the set-top box 104 via the wireless communication network 109. In other embodiments, the generated analytics report of user interaction or notifications are sent from the mobile device to set-top box 104 or headend 101 via other available networks, such as a cellphone network or the Internet.

In the example, mobile device(s) 110, 112, 113 can also retrieve from the memory, at a predetermined time period, a respective analytics report of user interaction for each of the plurality of advertisements. Mobile device(s) 110, 112, 113 may compile the respective analytics reports to generate a compiled analytics report of user interaction. Compiling the analytics reports can further include identifying from the retrieved analytics reports, the advertisements that have a shared advertising campaign identifier. The retrieved analytics reports having the shared campaign identifier may be grouped together in the compiled analytics report. The compiled analytics report of user interaction is sent to the set-top box over the wireless communication network 109 by the mobile device(s) 110, 112, 113. Alternatively, the individual analytics reports may be sent by the mobile device(s) 110, 112, 113 to the set-top-box 104 and the set-top-box 104 may compile the reports. As another alternative, the set-top-box may send the individual analytics reports to the headend 101 which may compile the reports.

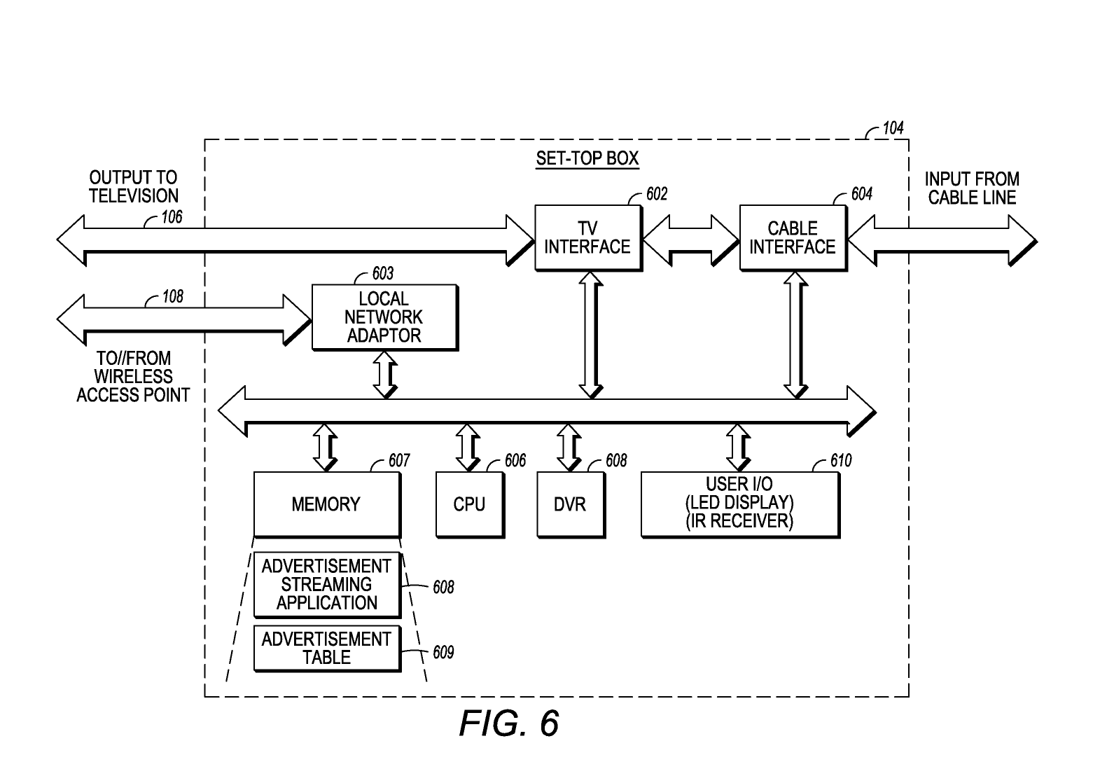

FIG. 6 shows a block diagram of an example STB 104. In this example, the STB 104 includes TV interface 602 for processing video and audio data, e.g. decoding an MPEG transport stream to output visual content for displaying on a television 106. The STB 104 also includes an interface for local communication with end user devices. In this example, that interface takes the form of a local network adaptor 603 for communication to/from the wireless access point 108. The STB 104 also includes cable interface 604 for receiving programming from the cable or satellite TV network 102 and for supplying selected MPEG transport streams to the TV interface 602. The example cable interface 604 also sends and receives data over the cable or satellite network 102 to the headend 101 to obtain the media content, such as transport streams, and possibly meta-data files or meta-data related instructions from the headend 101.

The example STB 104 also includes circuits forming one or more processors to implement a CPU 606 for controlling operations of the STB 104, including performing the processing of the media content and meta-data files, and digital video recorder (DVR) 608 for storing the media content and meta-data files. STB 104 may include one or more memories 607 and/or other program and data storage devices, for example, for storing instructions executable by the CPU 606 and a database. In the example, STB 104 may include an advertisement streaming application 608 to perform the functions or procedures as described above, for example in FIGS. 2-3 and an advertisement table 609 as described in FIG. 3. Alternatively, the media forming the storage for the DVR function 608 may serve as the instruction storage as well. Specific types of working memories such as RAM and ROM for the CPU 606 are omitted for convenience. The example set-top box communicates with mobile device(s) 110, 112, 113 via local network adaptor 603 (network communication interface).

The STB 104 also includes a user I/O device 610. The user I/O device 610 may include a light emitting diode (LED) or liquid crystal device (LCD) display for displaying information to the user watching the television 106. The user I/O device 610 may also include an infrared (IR) receiver for receiving instructions from the user's remote control.

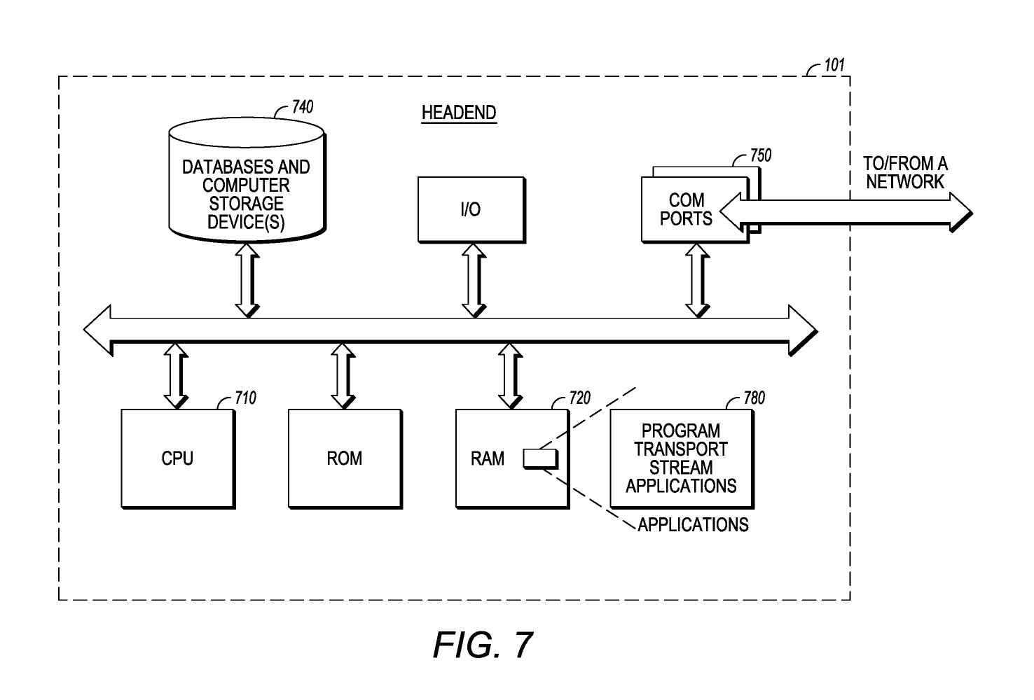

FIG. 7 shows an example of a hardware configuration that may be used in the headend 101 in FIG. 1, in simplified block diagram form. The computer may be configured as a server or host to function as any of the computer platforms in FIG. 1. For example, the vendor server 135 shown in the system of FIG. 1 may be implemented in a somewhat similar fashion, although the headend 101 is typically optimized for video and related cable TV type network services or the like.

The example headend 101 includes a CPU 710, in the form of one or more processors, for executing program instructions. Although the processor(s) forming the CPU 710 may be similar to the microprocessor used in the mobile device(s) 110, 112, 113 of FIG. 1, host or server computer platforms typically use somewhat different circuit architectures, e.g. to provide more processor power. Headend 101 also includes a memory 720, such as RAM, that is accessible to the processor to temporarily store program transport streams, analytics reports of user interaction, and program instructions for the processes that implement processing of the transport streams and the processing of the advertising analytics reports. Execution of the programming by the processor 710 configures the headend 101 to perform the functions or procedures as described above, for example in FIGS. 2 and 4.

In general, the term “application,” as used herein, refers to logic embodied in hardware or software instructions, which can be written in a programming language, such as Java™, C, C++, C Sharp, for example. A software application can be compiled into executable programs or written in interpreted programming languages, such as Perl, Visual Basic script, HTML, or JavaScript. Software applications may be callable from other applications. Generally, applications described herein refer to logical modules that may be merged with other modules or divided into sub-module despite their physical organization. The applications can be stored in any type of computer readable medium or computer storage device and be executed by one or more general purpose computers. In addition, the methods and processes disclosed herein can alternatively be embodied in specialized computer hardware or an application specific integrated circuit (ASIC).

The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

In this particular example, the headend 101 is shown as including the databases and computer storage device(s) 740, such as to persistently store program transport streams, analytics reports of user interaction, etc. as discussed earlier. The databases and computer storage device(s) 740 are accessible to the central processing unit (CPU) 710 of the headend 101.

The example headend 101 includes a network communication interface, shown generally as com ports 750, such as coaxial or optical communication ports. Com ports 750 allow the headend 101 to communicate with other devices and systems, via the cable or satellite network 102, such as set-top box 104. However, the com ports 750 may use any available data communication technology. In a fixed installation, for example, the com ports 750 may include an Ethernet interface card for communication over appropriate data network wiring. For a wireless implementation, the com ports 750 may include a WiFi transceiver or a telecommunications receiver.

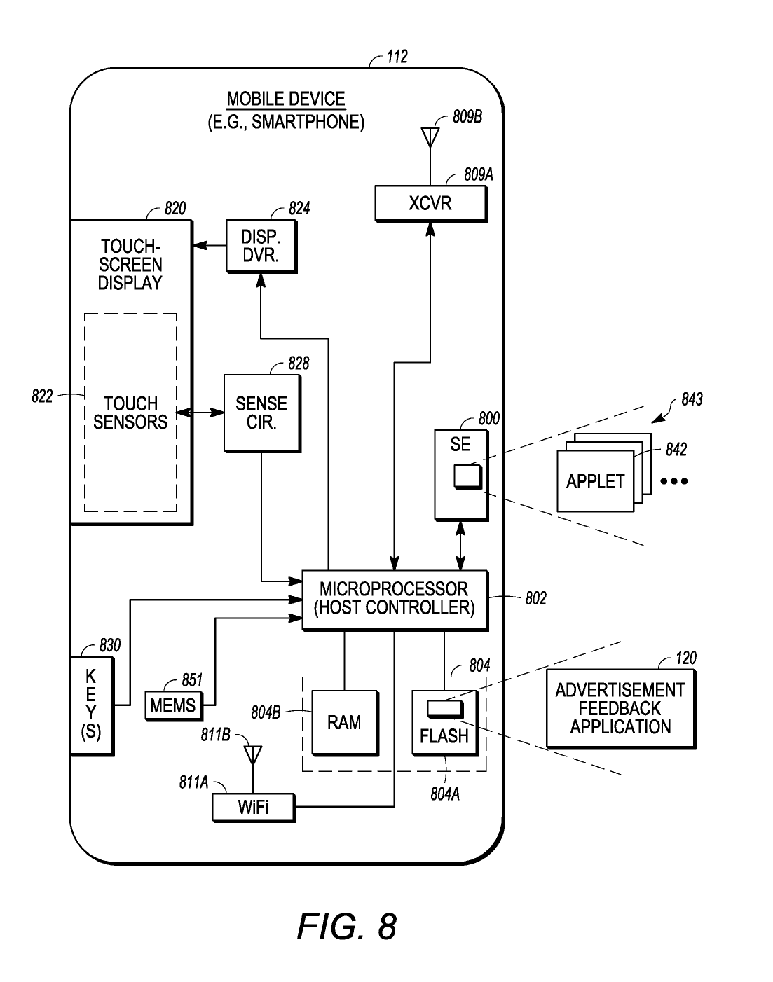

FIG. 8 is a high-level functional block diagram of an example of a mobile device, such as smartphone 112, that communicates via the system 100 of FIG. 1.

Shown are elements of a touch screen type of mobile device having the advertisement feedback application 120 loaded, although other non-touch type mobile devices can be used in the advertisement feedback communications under consideration here. Examples of touch screen type mobile devices that may be used include (but are not limited to) a smart phone, a personal digital assistant (PDA), a tablet computer, a laptop computer, or other portable device. However, the structure and operation of the touch screen type devices is provided by way of example; and the subject technology as described herein is not intended to be limited thereto. For purposes of this discussion, FIG. 8 therefore provides a block diagram illustration of the example smartphone 112 having a touch screen display for displaying content and receiving user input as (or as part of) the user interface.

The activities that are the focus of discussions here typically involve data communications. As shown in FIG. 8, the smartphone 112 includes at least one digital transceiver (XCVR) 809a, for digital wireless communications via a wide area wireless mobile telecommunication network, although the smartphone 112 may include additional digital or analog transceivers (not shown). The transceiver 809a (network communication interface) conforms to one or more of the various digital wireless communication standards utilized by modern mobile networks. Examples of such transceivers include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” For example, transceiver 809a provides two-way wireless communication of information including digitized audio signals, still image and/or video signals, web page information for display as well as web related inputs, and various types of mobile message communications to/from the smartphone 112.

Several of these types of communications through the transceiver 809a and a network, as discussed previously, relate to protocols and procedures in support of communications with the set-top box 104 and wireless access point 108 to retrieve and display questions related to the advertisement metadata, MPEG program transport streams with advertisements and to receive feedback on the effect/impact of the advertisements. Such communications, for example, may utilize IP packet data transport utilizing the digital wireless transceiver (XCVR) 809a and over the air communications to and from the set-top box 101 via the wireless access point 108 shown in FIG. 1.

In one example, the transceiver 809a sends and receives a variety of signaling messages in support of various data services provided by a network of a wireless service provider, to user(s) of smartphone 112 via a mobile communication network (not shown). Transceiver 809a connects through radio frequency (RF) send-and-receive amplifiers (not shown) to an antenna 809b.

Many modern mobile device(s), such as smartphone 112, also support wireless local area network communications over WiFi, instead of or in addition to data communications using the wide area mobile telecommunication network. Hence, in the example of FIG. 8, for packet data communications, smartphone 112 also includes a WiFi transceiver 811a and associated antenna 811b. Although WiFi is used here as the example, the transceiver 811a may take the form of any available two-way wireless local area network (WLAN) transceiver of a type that is compatible with one or more standard protocols of communication implemented in wireless local area networks, such as one of the WiFi standards under IEEE 802.11 and/or WiMAX. In addition, smartphone 112 can include a Bluetooth or ZigBee (IEEE 180.15) transceiver (not shown) to communicate and interact with proximate Bluetooth or other ZigBee-equipped devices, such as set-top box 104 or the other mobile devices shown in FIG. 1.

The transceiver 811a, for example, may provide two-way data transport for wireless communication with a wireless access point (shown in FIG. 1) in a residence or enterprise that the user frequents or with any available hotspot offered in a public venue. A WiFi access point 108 may communicate with compatible user equipment, such as the smartphone 112, over the air using the applicable WiFi protocol. The WiFi access point provides network connectivity. In a home or office premises, for example, the WiFi access point would connect directly or via a local area network (LAN) to a line providing internet access service. In a more public venue, an access point configured as a hotspot may offer similar connectivity for customers or others using the venue, on terms and conditions set by the venue operator. Although communicating through a different network or networks, the transceiver 811a supports various types of data communications similar to the packet data communications supported via the mobile network transceiver 809a, including communications related to communications to and from set-top box 104 and the other devices shown in FIG. 1.

The example smartphone 112 further includes a microprocessor, sometimes referred to herein as the host controller 802. A processor 802 is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 802, for example, may be based on any known or available microprocessor architecture, such as a Reduced Instruction Set Computing (RISC) using an ARM architecture, as commonly used today in mobile devices and other portable electronic devices. Of course, other processor circuitry may be used to form the CPU or processor hardware in smartphone 112, laptop computer 110, and tablet 113.

Returning more specifically to the smartphone 112 example of FIG. 8, the microprocessor 802 serves as a programmable host controller for the mobile device by configuring the mobile device to perform various operations, for example, in accordance with instructions or programming executable by processor 802. For example, such operations may include various general operations of the smartphone 112, as well as operations related to communications with set-top box 104. Although a processor may be configured by use of hardwired logic, typical processors in mobile devices are general processing circuits configured by execution of programming.

The smartphone 112 includes a memory or storage system 804, for storing data and programming. In the example, the memory system 804 may include a flash memory 804a and a random access memory (RAM) 804b. The RAM 804b serves as short term storage for instructions and data being handled by the processor 802, e.g. as a working data processing memory. The flash memory 804a typically provides longer term storage.

Hence, in the example of smartphone 112, the flash memory 804a is used to store programming or instructions for execution by the processor 802. Depending on the type of device, the smartphone 112 stores and runs a mobile operating system through which specific applications, including advertisement feedback application 120 (which may be a web browser executing a dynamic web page), run on smartphone 112. Examples of mobile operating systems include Google Android, Apple iOS (I-Phone or iPad devices), Windows Mobile, Amazon Fire OS, RIM BlackBerry operating system, or the like. Flash memory 804a may also be used to store mobile configuration settings for different mobile applications or services executable at smartphone 112 using processor 802.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

The tablet computer 113, laptop computer 110, and wireless access point 108 of FIG. 1 can be implemented in a somewhat similar fashion. A computer type user terminal device such as a PC, laptop computer, or tablet computer similarly includes one or more data communication interfaces (represented by COM ports), circuits forming one or more processors to implement a central processing unit (CPU) functionality, main memory and one or more mass storage devices for storing user data and the various executable programs for requesting and reproducing media content and receiving and processing indications as well as meta-data files containing information to facilitate content reproduction. A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Program aspects of the technology may be thought of as “products” or “articles of manufacture” typically in the form of executable code and/or associated data that is carried on or embodied in a type of machine readable medium. For example, programming code could include code for the server or the sending device for generating meta-data files and programming for the receiving device for reproducing content based on the meta-data files. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service provider into the computer platforms of the media gateway and client device. Thus, another type of media that may bear the programming, media content or meta-data files includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to “non-transitory”, “tangible”, or “storage” media, terms such as computer or machine “readable medium” refer to any medium that participates in providing instructions or data to a processor for execution.

Hence, a machine readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A set-top box, comprising:
a network communication interface;
a processor coupled to the network communication interface;
a memory accessible to the processor; and
programming in the memory, wherein execution of the programming by the processor configures the set-top box to perform functions, including functions to:
receive a program transport stream from a headend via a cable or satellite network, the program transport stream including an advertisement identified by a data packet identifier (PID), the advertisement having at least one advertisement packet with the data PID and advertisement metadata;
upon determining that the data PID identifies the advertisement, extract advertisement metadata from the at least one advertisement packet in the program transport stream;
send the extracted advertisement metadata to a mobile device over a wireless communication network;
in response to sending the extracted advertisement metadata to the mobile device, receive an analytics report of user interaction with the extracted advertisement metadata from the mobile device over the wireless communication network; and
send the analytics report of user interaction with the extracted advertisement metadata to the headend via the cable or satellite network.

2. The set-top box of claim 1, wherein extracting the advertisement metadata includes:
parsing at least one of a company name, a product name, a web site address, a phone number, a mailing address, and an advertising campaign identifier that corresponds to the advertisement from the advertisement metadata of the at least one advertisement packet; and
storing the parsed advertisement metadata in an advertisement database in the memory of the set-top box.

3. The set-top box of claim 2, wherein sending the extracted advertisement metadata to the mobile device over the wireless communication network includes:
retrieving the parsed advertisement metadata from the advertisement database;
generating at least one wireless communication network packet that includes the extracted advertisement metadata as one or more parameters; and
transmitting the generated at least one wireless communication network packet to the mobile device over the wireless communication network.

4. The set-top box of claim 3, wherein the analytics report of user interaction with the extracted advertisement metadata includes:
(i) an indication of selection of the advertisement by a user of the mobile device; and
(ii) an event that specifies an action including at least one of: no interaction, visitation of the web site address by the user, calling of the phone number by the user, sharing of the extracted advertisement metadata with another user, and purchase of a product advertised in the advertisement.

5. The set-top box of claim 4, wherein the analytics report of user interaction with the extracted advertisement metadata is sent to the headend via the cable or satellite network in accordance with the data over cable service interface specification (DOCSIS).

6. The set-top box of claim 1, wherein the program transport stream is a moving picture experts group (MPEG) transport stream.

7. The set-top box of claim 1, wherein the wireless communication network is a local area network (LAN) and the extracted advertisement metadata is sent to the mobile device via a network gateway over the LAN.

8. The set-top box of claim 7, wherein the wireless communication network is network operating according to Bluetooth, ZigBee, or WiFi protocol.

9. A method comprising:
sending from a headend to a set-top box via a cable or satellite communication network, a program transport stream including metadata of an advertisement identified by a data packet identifier (PID), the advertisement having at least one advertisement packet with the PID and the advertisement metadata;
in response to sending the advertisement metadata, receiving at the headend from the set-top box an analytics report of user interaction with the advertisement metadata at a mobile device;
storing at the headend the analytics report of user interaction in a database;
compiling at the headend and at a predetermined time the analytics report of user interaction with other analytics reports of user interaction to generate a compiled analytics report of user interaction; and
transmitting the compiled analytics report of user interaction to a vendor server.

10. The method of claim 9, wherein the advertisement metadata includes at least one of a company name, a product name, a web site address, a phone number, a mailing address, and an advertising campaign identifier that corresponds to the advertisement.

11. The method of claim 10, wherein the analytics report of user interaction with the advertisement metadata includes:
(i) an indication of display of the advertisement to a user of the mobile device; and
(ii) an event that specifies an action including at least one of: no interaction, visitation of the web site address, calling of the phone number, sharing of the extracted advertisement metadata with another user, and purchase of the product.

12. The method of claim 9, wherein storing at the headend the analytics report of user interaction in the database includes:
extracting the advertising campaign identifier from the analytics report of user interaction; and
storing the analytics report using the advertising campaign identifier in the database along with an identity of the user, a date of user interaction, and a time of user interaction as one or more fields in a record of the database.

13. The method of claim 12, wherein compiling the analytics report of user interaction with other analytics reports of user interaction to generate a compiled analytics report of user interaction includes:
retrieving from the database analytics reports having a shared advertising campaign identifier; and
combining the retrieved analytics reports having the shared campaign identifier to generate the compiled analytics report of user interaction.

14. A non-transitory machine-readable medium containing machine-readable programming instructions, the instructions causing a mobile device to:
receive at a mobile device a program transport stream and a plurality of advertisements associated with the program transport stream from a set-top box via a wireless communication network, each advertisement including respective advertisement metadata;
store the plurality of advertisements including respective advertisement metadata in a memory;
launch an application by a processor of the mobile device;
present a user interface display of the launched application on a touchscreen display device of the mobile device, the user interface display including a list of the plurality of advertisements;
in response to an input on the touchscreen display selecting an advertisement from the plurality of advertisements by a user of the mobile device, monitor user interaction with the selected advertisement; and
generate an analytics report of user interaction with the selected advertisement, the analytics report of user interaction including: (i) an indication of selection of the selected advertisement, and (ii) an event specifying an action taken with the respective advertisement metadata;
store the generated analytics report in the memory of the mobile device; and
send the analytics report of user interaction with the selected advertisement to the set-top box via the wireless communication network.

15. The non-transitory computer readable medium of claim 14, wherein the respective advertisement metadata includes least one of a company name, a product name, a web site address, a phone number, a mailing address, and an advertising campaign identifier.

16. The non-transitory computer readable medium of claim 15, wherein the event specifying the action taken with the respective advertisement metadata is at least one of: no interaction, visitation of the web site address, calling of the phone number, sharing of the respective advertisement metadata with another user, and purchase of the product by the user.

17. The non-transitory computer readable medium of claim 14, wherein storing the respective advertisement metadata in the memory includes:
parsing at least one of a company name, a product name, a web site address, a phone number, a mailing address, and an advertising campaign identifier that corresponds to the advertisement from at least packet of the advertisement metadata; and
storing the parsed advertisement metadata in an advertisement table in the memory of the mobile device.

18. The non-transitory computer readable medium of claim 14, wherein the instructions further cause the mobile device to:
retrieve at a predetermined time from the memory a respective analytics report of user interaction for each of the plurality of advertisements;
compile the respective analytics report of user interaction for each of the plurality of advertisements to generate a compiled analytics report of user interaction; and
transmit the compiled analytics report of user interaction to the set-top box over the wireless communication network.

19. The non-transitory computer readable medium of claim 18, wherein compiling the analytics report of user interaction for each of the plurality of advertisements further includes:
identifying from the retrieved analytics reports, the advertisements that have a shared advertising campaign identifier; and
grouping the retrieved analytics reports having the shared campaign identifier together in the compiled analytics report of user interaction.

20. The non-transitory computer readable medium of claim 18, wherein the wireless communication network is a mesh network, a local area network (LAN) or a personal area network (PAN).
